(19) United States
(12) Patent Application Publication
(10) Pub. No.: US 2013/0339337 A1
(43) Pub. Date: Dec. 19, 2013

(54) AUTO TAGGING METHOD AND SYSTEM

(71) Applicant: CompanyID Corporation, Toronto (CA)

(72) Inventors: Raad ALKHATEEB, Toronto (CA); Kumar ERRAMILLI, Toronto (CA)

(21) Appl. No.: 13/905,117

(22) Filed: May 29, 2013

Related U.S. Application Data
(60) Provisional application No. 61/653,403, filed on May 30, 2012.

(51) Int. Cl. G06F 17/30

(52) U.S. Cl. CPC G06F 17/30864
USPC 707/710

(57) ABSTRACT

A method for categorizing content from a website associated with an enterprise company for ranking of said company, said method performed by a computing device having a processing structure; and a memory including instructions executable by said processing structure to cause said processing structure to at least: request a uniform resource locator (URL) associated with the website; validate the URL; create a profile associated with the enterprise company and storing the URL in the memory; automatically crawl the website for content and to create a site index; parse the content to determine the occurrence of a predefined set of keywords pertaining to products and services and business activities of the company, and rank the keywords according to relevance pertaining to at least one category; categorize the website into at least one industry category; and determine whether the website is properly categorized.

### CROSS-REFERENCE TO RELATED APPLICATIONS

This application claims the benefit of priority to U.S. Provisional Application Ser. No. 61/653,403, filed on May 30, 2012.

### FIELD OF THE INVENTION

The present invention relates to social bookmarking, more particularly it relates to automatically categorizing websites into categories.

### DESCRIPTION OF THE RELATED ART

Social media includes tools used for online communication, such as instant messaging, text chat, blogs, wikis, social network services, social guides, social bookmarking, social citations, social libraries and virtual worlds. Social bookmarking sites allow people to share bookmarks for internet pages by assigning keywords, or tags, of their own choice to describe the sites that they find appealing. Tagging creates a grass-roots taxonomy for the shared bookmarks. Users can search by tags to find bookmarks that appeal to their interests, and thus obtain more relevant results than a typical web search.

Most business buyers today start their search for products and services online using search engines such as Google™, from Google Inc., U.S.A., or Bing™ from Microsoft Corporation, U.S.A. However, these search engines typically provide results that may be irrelevant for the business buyers who are looking for products, services, or potential trade partners. As an example, suppose a business buyer is searching for an industrial seal, and enters the term “seal” as a search query, the search engine results range from Navy SEALs to marine mammals. Therefore, it would take a considerable amount of time to find the results that are actually relevant to industrial seals.

To address the problem associated with the search engines above, business to business (B2B) portals have been proposed. These B2B portals allow the sharing of bookmarks associated with businesses, including vertical searches. However, these B2B portals follow the current established trend of retrieving manually entered user information from the user. However, research has shown that business-to-business (B2B) website search success rate is about 58%, and approximately 30% of visitors abandon the site with each failed query. Therefore, users from companies that sign up to these B2B platforms are tasked to provide information about their company's products, services, country of origin, and other relevant keywords for search engine optimization, so they may be readily discovered by others. As the content on these B2B platforms is user generated, this approach is prone to human error and misclassifications of businesses, thus resulting in erroneous search results. Another drawback of these prior art B2B solutions is that the process involves laborious forms which must be completed by the user, and in most cases these forms are replete with incorrect or incomplete information. In the worst case scenario, the form completion endeavour is abandoned due to frustration, or the inability to respond to the questions within the form completely, or due lack of time resources.

It is an object of the present invention to mitigate or obviate at least one of the above-mentioned disadvantages.

### SUMMARY OF THE INVENTION

In one of its aspects there is provided a method for categorizing content from a website associated with an enterprise company for ranking of said company, said method performed by a computing device having a processing structure; and a memory including instructions executable by said processing structure to cause said processing structure to at least: request a uniform resource locator (URL) associated with said website; validate said URL; create a profile associated with said enterprise company and storing said URL in said memory; automatically crawl said website for content and to create a site index; parse the content to determine the occurrence of a predefined set of keywords pertaining to products and services and business activities of said company, and rank said keywords according to relevance pertaining to at least one category; categorize said website into at least one industry category; and determine whether the website is properly categorized.

In another of its aspects, there is provided an auto tagging system for categorising a company, the system comprising: a uniform resource locator (URL) validator to validate at least one URL associated with said company; an email address verifier for verifying an email address associated with said company; a URL list database; a crawler for crawling a website associated with said least one URL for content to create a site index for entry in a crawler database, a parser for parsing the content of said crawled at least one URL; and a rank categorizer for categorizing at least one the URL into a category.

The method includes crawling public directories, worldwide tradeshows, and government directories using data mining software and web crawlers, and then automatically categorizing companies based on their products, services and location without any human interaction.

In yet another of its aspects, there is provided a computer-implemented method for discovering content associated with a company, the method having the steps of: categorizing content associated with said company into at least one category; assigning a unique identifier to said company; creating a profile of said company; automatically crawling at least one uniform resource locator (URL) associated with a website of said company for content on a predetermined basis, and to create a site index; parsing the content to determine the occurrence of a predefined set of keywords pertaining to products and services and business activities of said company; ranking said keywords according to relevance pertaining to at least one category; and providing said content in real-time based on predefined rules.

Advantageously, the method and system for automatically categorizes a website into a B2B subcategory within a B2B category based on a set of B2B keywords related to products and services. The process for setting up a user profile for a company involves providing a URL of the company such that the profile only consists of the company URL or website. The process is thus more user-friendly and faster than prior art methods, and by limiting human intervention the categorization results are more accurate than prior art manual processes. Also, the process minimizes the wastage of resources from both the user's point of view and the back-end point of view. By having the profile as a website and automatically extracting the user information extraction from their website, rather than asking the user to input their information, saves time and resources and also minimizes any possible human interaction errors.

### BRIEF DESCRIPTION OF THE DRAWINGS

Several exemplary embodiments of the present invention will now be described, by way of example only, with reference to the appended drawings in which:

FIG. 1 shows an exemplary auto tagging system;

FIG. 2 shows a schematic diagram of an exemplary participant computing device;

FIG. 3 shows components of an exemplary auto tagging tool;

FIG. 4 is a flow chart diagram illustrating an exemplary method for auto tagging websites;

FIGS. 5a to 5g show exemplary user-interfaces for use with the system of FIG. 1.

FIGS. 6a to 6c show exemplary user-interfaces for use with the system of FIG. 1, in another embodiment

### DETAILED DESCRIPTION OF EXEMPLARY EMBODIMENTS

The detailed description of exemplary embodiments of the invention herein makes reference to the accompanying block diagrams and schematic diagrams, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and its best mode and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Many of the methods of the invention may be performed with a digital processing system, such as a conventional, general purpose computer system. Special purpose computers which are designed or programmed to perform only one function may also be used. FIG. 1 shows an exemplary auto tagging system, generally identified by reference numeral 10, comprising a plurality of computing devices 12 in communication with an auto tagging tool 14 for classifying and categorizing content and/or websites/URLs into categories. The computing devices 12 are communicatively coupled to the auto tagging tool 14 via a network 16, either though a wired connection, or a wireless connection. For example, the network 16 may be the Internet, or a mixture of different networks.

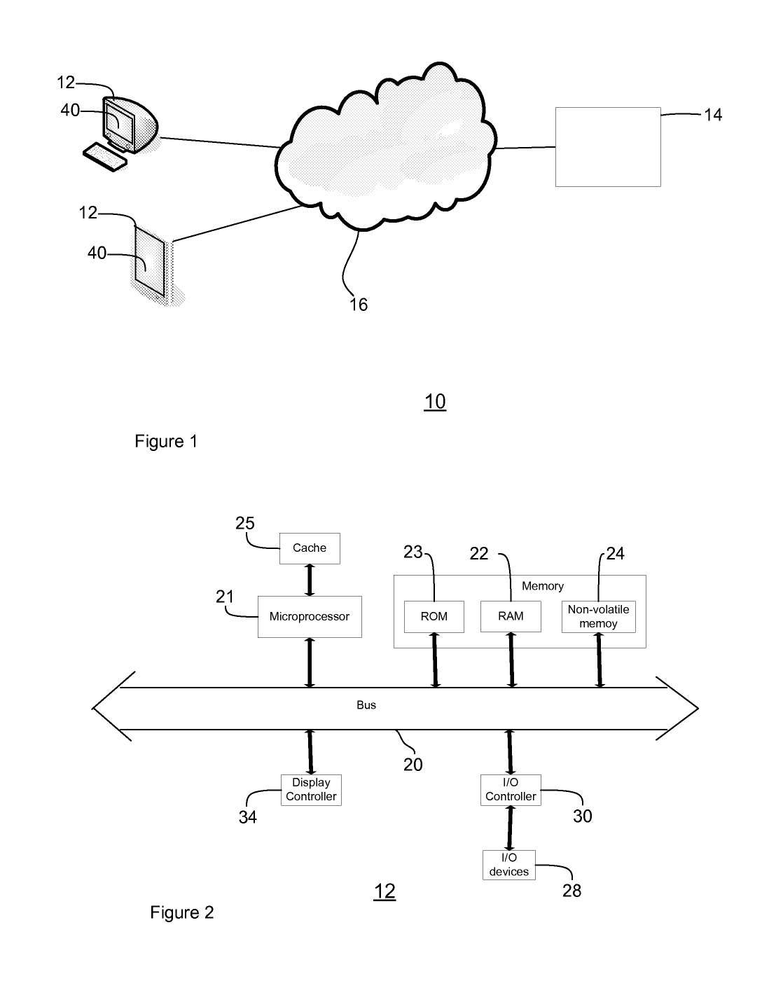

FIG. 2 shows one example of a typical computer system of device 12. Note that while FIG. 2 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention. The computing system may be in the form of any kind of general processing structure, and may for example include any computing device 12, such as, a personal computer, a laptop, a tablet, a computer server, a computerized kiosk, a cellular phone, and a smartphone.

The computer system, which is a form of a data processing system, includes a bus 20 which is coupled to a microprocessor 21 and a read only memory (ROM) 22 and volatile random access memory (RAM) 23 and a non-volatile memory 24. The microprocessor 21 is coupled to cache memory 25. The bus 20 interconnects these various components together and also interconnects these components 21, 22, 23, and 24 to a display controller 34 and to peripheral devices such as input/output (I/O) devices 28 which may be mice, keyboards, modems, network interfaces, printers, scanners, video cameras and other devices which are well known in the art. Typically, the input/output devices are coupled to the system through input/output controllers 30. The bus 20 may include one or more buses connected to each other through various bridges, controllers and/or adapters as is well known in the art.

It will be apparent from this description that aspects of the present invention may be carried out in a computer system or other data processing system in response to its processor, such as a microprocessor, executing sequences of instructions contained in a memory. In various embodiments, hardwired circuitry may be used in combination with software instructions to implement the present invention. Thus, the techniques are not limited to any specific combination of hardware circuitry and software nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor, such as the microprocessor 21. The machine readable medium includes any mechanism that provides (i.e., stores and/or transmits) information in a form accessible by a machine (e.g., a computer, network device, personal digital assistant, any device with a set of one or more processors, etc.). For example, machine readable media includes recordable/non-recordable media (e.g., ROM; RAM; magnetic disk storage media; optical storage media; flash memory devices; etc.), as well as electrical, optical, acoustical or other forms of propagated signals (e.g., carrier waves, infrared signals, digital signals, etc.).

Each of the computing devices 12 comprises a graphical user interface (GUI), such as display screen 40 on which information is displayed. The GUI includes, but is not limited to, the “desktop” of the operating system, controls such as taskbars and scroll bars, any icons and application windows. Thus, the GUI allows information to be presented on devices 12 in windows.

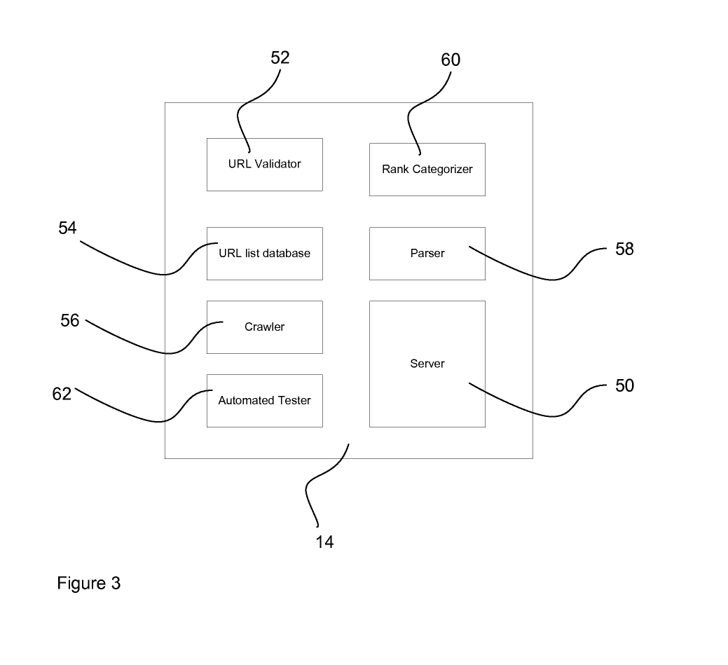

In more detail, as shown in FIG. 3, the tool 14 comprises a similar computing system as described above, however, it may further comprise data structures, such as, databases which stores classification information in the form of tag information. Further, the tool 14 performs associated functions with the tag information. Tool 14 may include a server process 50 that responds to requests from one or more client programs. The process may include, for example, an HTTP server or other server-based process (e.g., a database server process, XML server) that interfaces to one or more client programs distributed among one or more client systems. The tool 14 further comprises a URL validator 52, a URL List database 54, a crawler 56, a parser 58, a rank categorizer 60, and an automated quality assurance (QA) tester 62, the functions of which will be described below.

In one exemplary embodiment, the auto tagging tool 14 provides a B2B platform that automatically categorizes a website/URL into a B2B subcategory within a B2B category based on a set of B2B keywords related to products and services. The categorization is based on data extracted from the website/URL. Any particular website/URL may be classified more than one B2B category or subcategory based on their products/services. Preferably, the indexed content crawled from company websites is categorized using keywords from ten-digit Harmonized System (HS) codes used by the United States to track international trade and the Standard Industrial Classification (SIC) and North American Industry Classification System (NAICS) categories used to characterize domestic production.

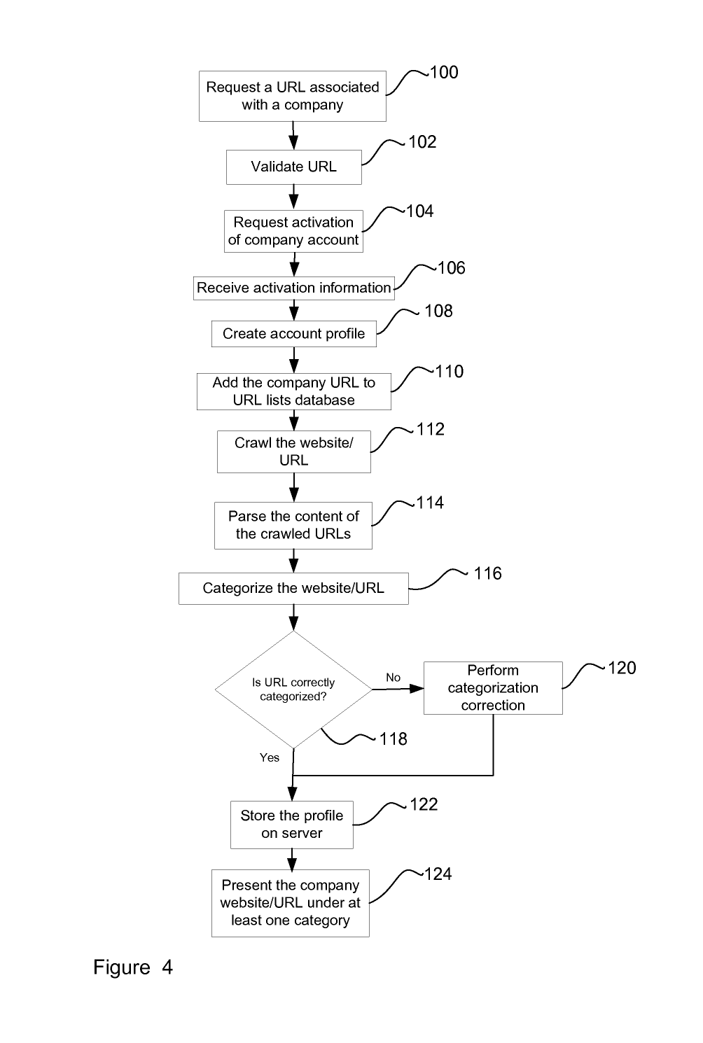

Looking at FIG. 4, a flow chart diagram illustrates an exemplary method for an automated B2B tagging system based on a set of B2B predefined keywords. An enterprise company may be added to the B2B social bookmarking platform by providing only a URL or an email address associated with the enterprise company, thus making the signup process less onerous to the user compared to prior art methods. Therefore, the process comprises the steps of: requesting via HTTP or HTTPS a URL or email address associated with an enterprise company to set up a profile on the B2B platform, and receiving user input (step 100); using the URL validator 52 to validate the company URL based on the response received from the request (step 102), thus combating spam; sending an email message to the verified email address provided during signup requesting activation by the user (step 104); receiving activation confirmation from the user (step 106); automatically creating an account profile associated with the enterprise company (step 108); adding the company URL to the list of URLs stored in a URL list database 54 (step 110); crawling the URLs with a crawler 56 to create a site index for entry in a crawler database, the crawler 56 may be further instructed to crawl the URLs periodically, such as daily, weekly or monthly to update the site index (step 112); parsing the content of the crawled URL through several parsing algorithms which determine the density of B2B keywords and ranks the keywords according to relevance pertaining to a B2B subcategory using a parser 58, and building a data structure (step 114); based on the URL rank from the parse algorithms, using a rank categorizer 60 categorizing the URL into its respective categories and populating a database associated with the rank categorizer 60 (step 116); once the URL has been successfully categorized, searching the system for the categorized URL to determine whether the URL is properly categorized with an automated quality assurance (QA) tester 62, (step 118); when a URL is determined to be in an incorrect B2B category or subcategory, then performing proper categorization to remedy the problem (step 120); storing the company profile on server 50 (step 122); and presenting the company website/URL under at least one category on a user interface 40, such as via a browser (step 124), the user-interface 40 may include a dialog box for inputting queries to a search engine associated with server 50.

Advantageously, the auto tagging tool 14 reduces the possibility of human errors during the tagging process by eliminating the manual tagging process of prior art systems, and is also considerably faster than manual tagging. The tool 14 also ensures increased quality in the categorized data with less chances of false tagging by users, such that the enterprise companies are categorized in accordance to the crawled content of their websites. Accordingly, accurate categorization by the auto tagging tool 14 improves the search quality, and enriches the quality of companies within each industry thus making the user's experience as vertical as possible while searching for a product or a service.

Once signed in, the user is able to initiate the discovery process for companies by selecting an icon or text associated a category of products or services. For example, once a product is selected, the user is directed to a list of companies that supply the selected product, and can then add a desired company as a supplier. In addition, the user is able to view the number of times a particular company has been added by other companies. This feature tackles another business problem which is the supplier/customer trust as companies can look for referrals when it comes to evaluating a new business partners online.

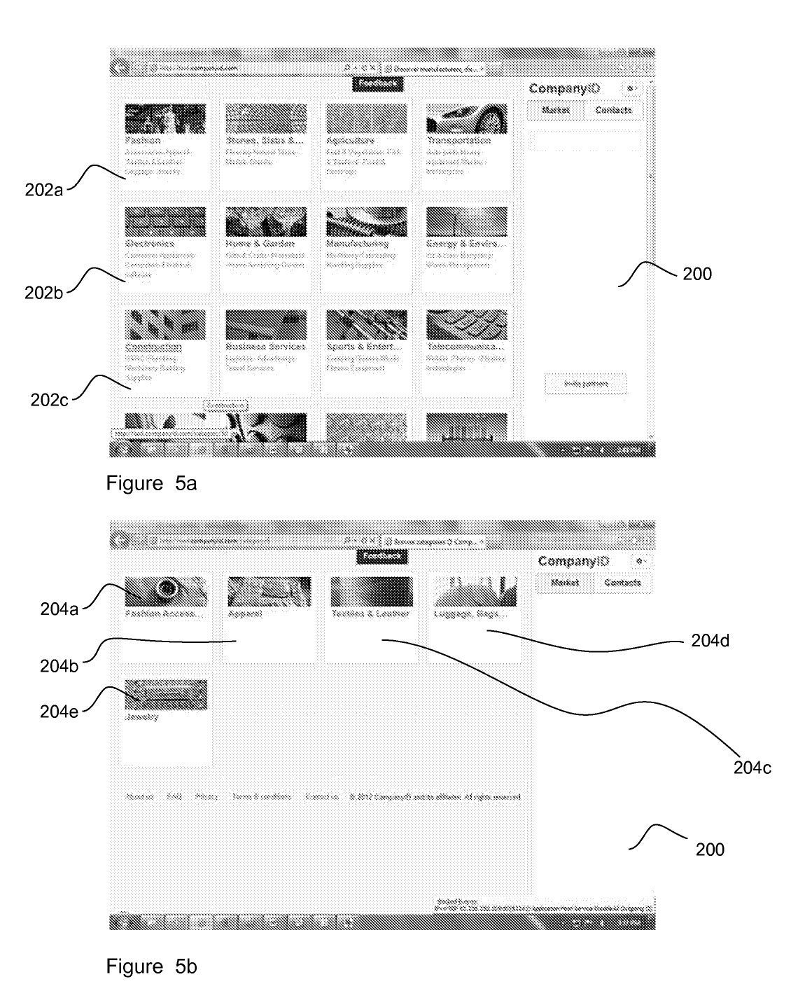

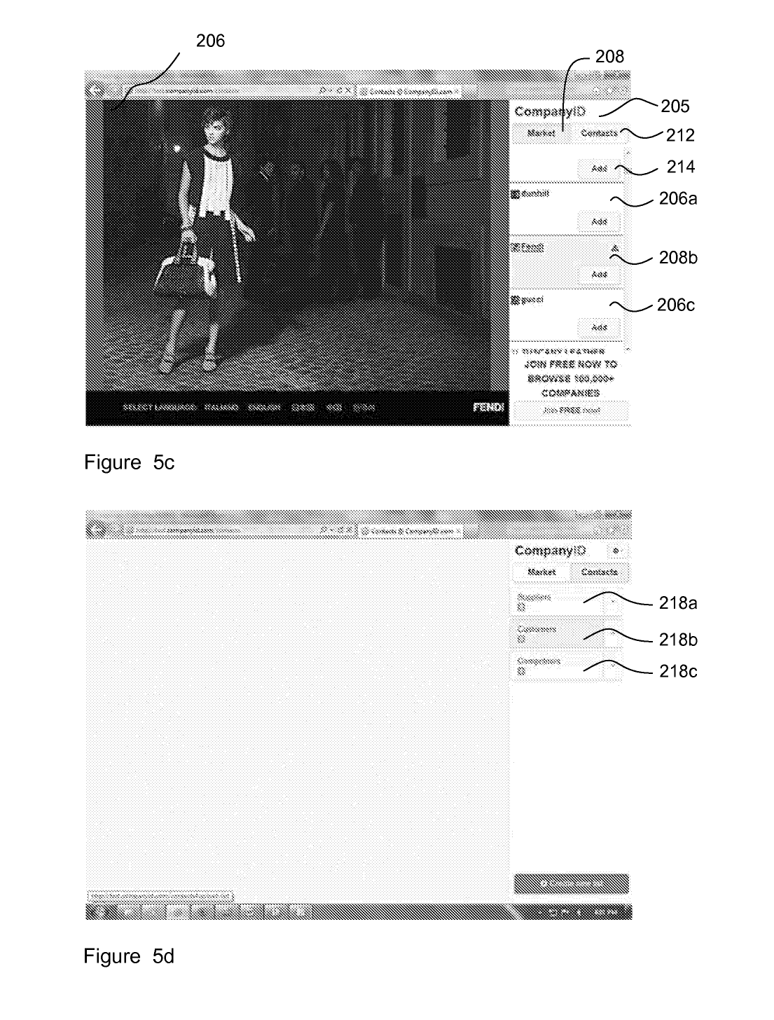

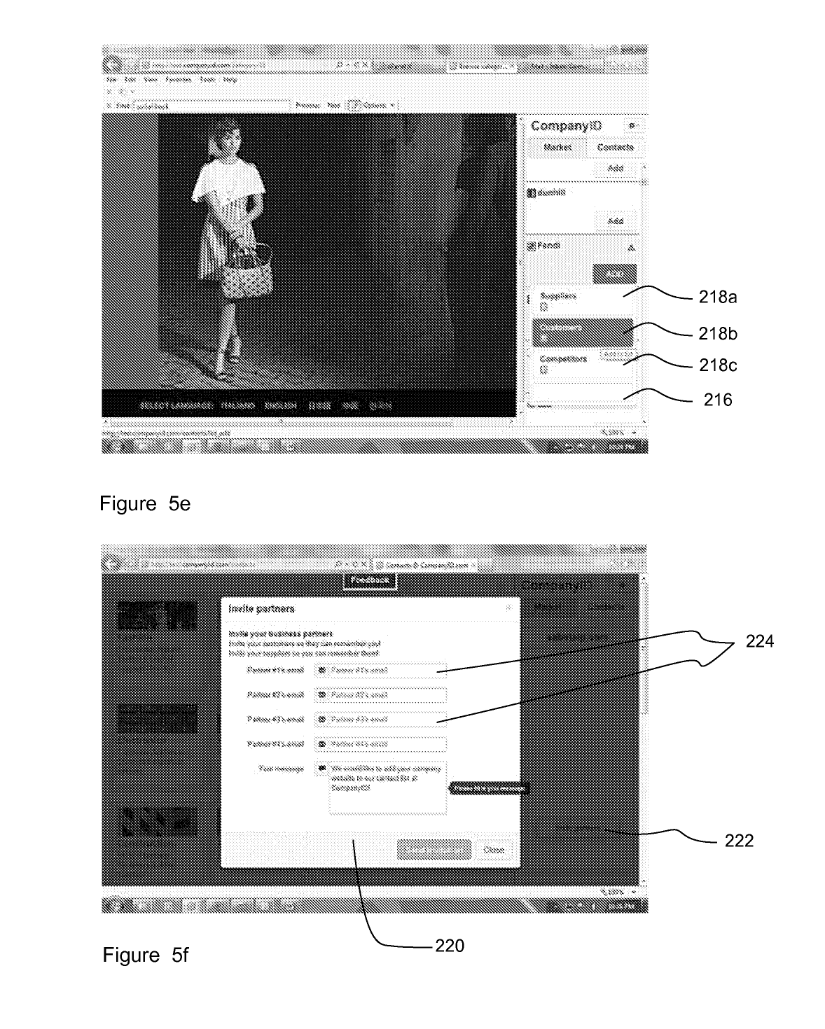

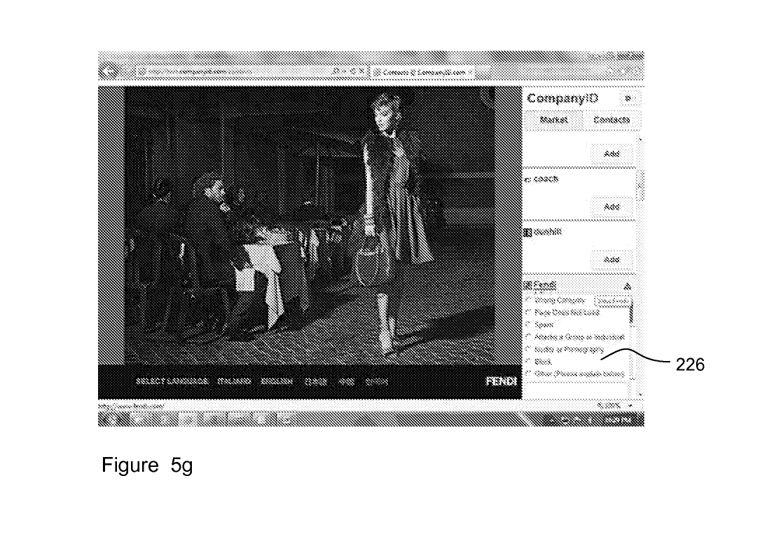

Looking at FIG. 5a, there is shown an exemplary user interface 200 with a plurality of main categories related to a variety of industry activities or markets. For example, the categories may include icons or text 202a, 202b, 202c corresponding to fashion; agriculture; transportation; electronics; home and garden; manufacturing, and so forth. The main categories comprise further sub-categories which allow further refining of the chosen market, such that the icons or text 202a, 202b, 202c are hyperlinked to the corresponding sub-categories. For example, if an icon or text 202a associated with a “Fashion” category is selected, then sub-categories corresponding to fashion accessories 204a; apparel 204b; textiles and leather 204; luggage and baggage 204d and jewelry 204e, are presented, as shown in FIG. 5b. If, for example, the icon 204d associated with the luggage and baggage sub-category is selected then a plurality of matching enterprise companies are presented on the user-interface 200. As shown in FIG. 5c, the user-interface 200 comprises a webpage having a first portion 205 and second portion 206. The first portion 205 comprises a “Market” button 208 which when actuated displays a list of enterprise companies 210a, 210b, 210c, related to the selected sub-category. A “Contacts” button 212 also within the first portion 205 allows a user to classify the different companies in user-defined categories, such as, supplier, customer or competition by selecting an “Add” button 214, as shown in FIGS. 5d and 5e. Upon selection of the “Add” button 214, a window overlay 216 having the user-defined categories represented by corresponding buttons, such as a “Suppliers” 218a, a “Customer” 218b or a “Competition” 218c, is presented. Looking again at FIG. 5c, the second portion 206 displays a website corresponding to one of the enterprise companies 210a, 210b, or 210c. For example, when one of the enterprise companies 210c is selected then the website corresponding to company 210c is presented in the portion 206. The displayed website is exactly the same as the website of company 210c that is accessible on the Internet. Therefore, any changes or updates performed by a web administrator of company 210c are reflected on the enterprise company's profile, such that the profile is always up to date. Users can browse the different enterprise companies 210a, 210b, 210c and a user can add any enterprise company 210a, 210b or 210c to a contact list using the button 214 associated with each enterprise company 210a, 210b or 210c. Therefore, unlike prior art B2B portals which only comprise profiles of companies and their list of products and services on one webpage, with system 10 a user can directly access the company's website from within the tool 14 via the user interface 40 of the B2B platform.

Referring once again to FIG. 5e, a user can add a new company to the contacts list, and place that company into one of the user-defined categories e.g. supplier, customer or competition, by simply entering the company's URL. In addition, the user can edit the list, including renaming the list, adding or deleting the list.

FIG. 5f shows an exemplary user interface 200 with a pop-up window 220 that may be invoked through actuation of a button 222 in the first portion 205 to invite business partners. The window 220 includes a form having plurality of text fields 224 for inputting email addresses of prospective partners. Once the fields 224 are populated, the invitation is automatically sent to the server 50 upon actuation an appropriate submit button.

FIG. 5g shows an exemplary user interface 200 with a reporting window 226 which can be invoked for each company, such a company 210c. The reporting window 226 allows a user to provide feedback related to the categorization of the company 201c or report violation of the platform rules. The feedback options include: wrong category, page does not load, spam, among others.

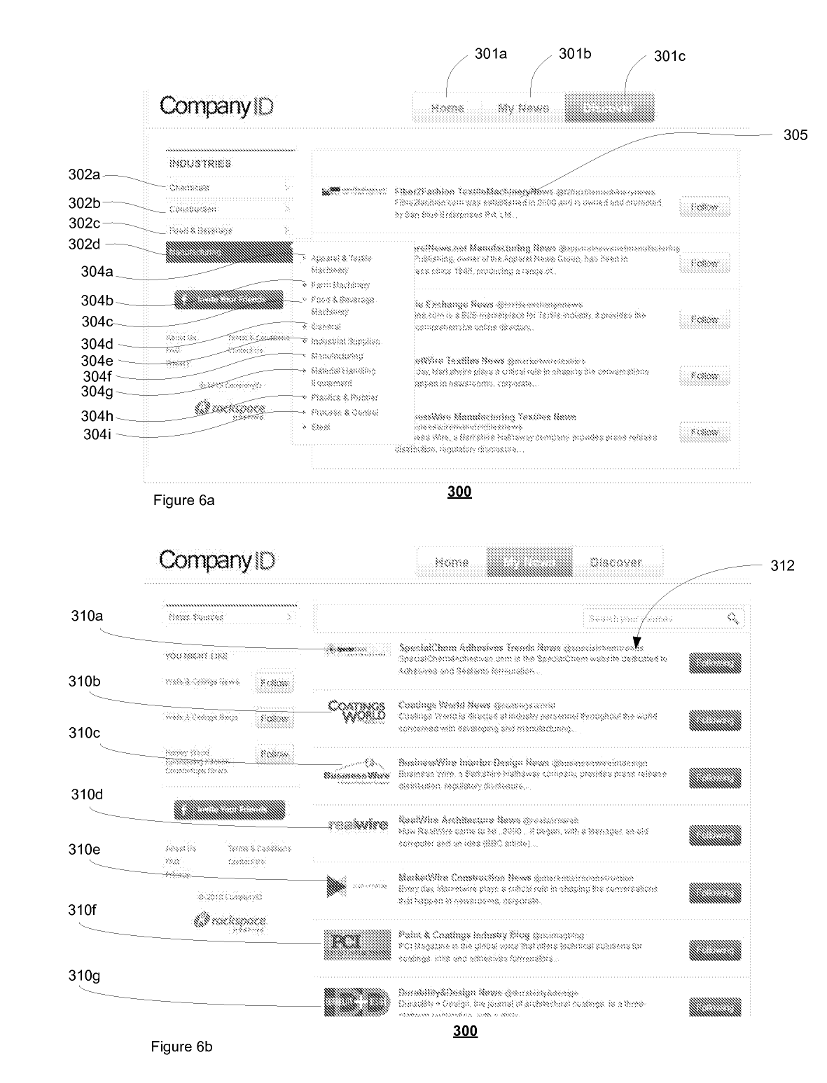

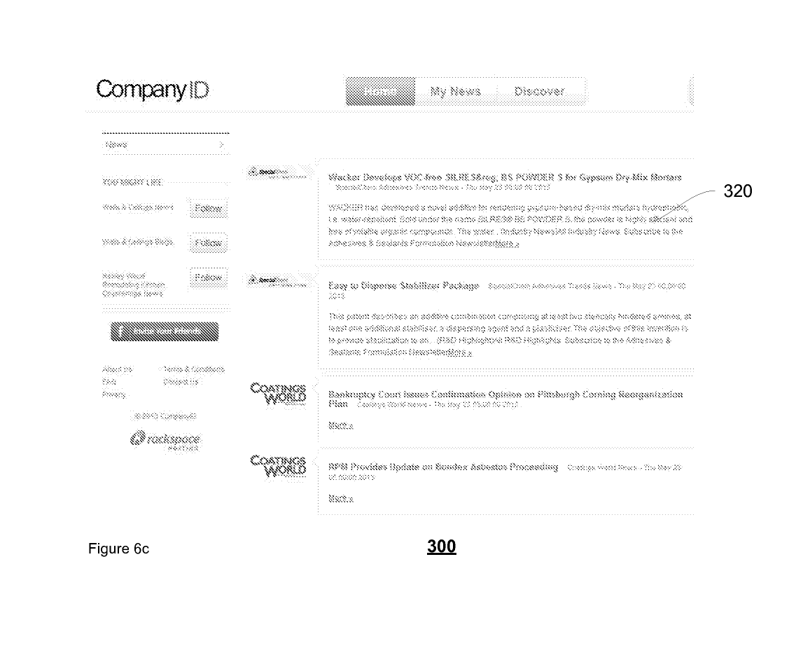

In another embodiment, the auto tagging tool 14 allows aggregation of news related to businesses. FIG. 6a shows an exemplary user interface 300 including tabs 301a, 301b, 301c corresponding to a “Home” page, “My News” page, and a “Discover” page, respectively. Selecting tab 301c presents a UI 300 having a plurality of industry categories to choose from as news sources. For example, the industry categories are associated with icons or text 302a, 302b, 302c, 302d corresponding to chemicals, construction, food and beverages, and manufacturing, and so forth. The main industry categories comprise further sub-categories which allow further refining of the chosen industries, such that the icons or text 302a, 302b, 302c, 302d are hyperlinked to the corresponding sub-categories. For example, if an icon or text 302d associated with a “Manufacturing” industry category is selected, then sub-categories corresponding to apparel & textile machinery 304a; farm machinery 304b; food & beverage machinery 304c; general 304d; industrial suppliers 304e; manufacturing 304f; material handling equipment 304; plastics & rubber 304h; process and control 304i; and steel 304i. If, for example, the icon or text 304a associated with the apparel & textile machinery sub-category is selected then a plurality of related news sources 305 are presented on the user-interface 300. The news may be sourced from press releases, worldwide, tradeshows, public directories, government directories, and so forth.

FIG. 6b shows an exemplary user interface 300 with a plurality of news sources, following a selection of the “My News” page tab 301b presents a UI 300 having a plurality of news sources 310a to 310g. The news sources 310a to 310g relate to the industries chosen by the user under the “Discover page”, as described above. The user interface 300 also comprises a search field 320 for inputting queries related to industry news items or sources 312.

FIG. 6b shows an exemplary user interface 300 with aggregated news articles 320 corresponding to the chosen industries, under the home tab 301a.

Advantageously, the tool 14 facilitates lead generation as companies can promote their websites on the Internet and within the B2B sector in an effortless manner to generate more leads as other users or visitors can view the company's products and services directly on their website rather than a flat profile. The tool 14 directs B2B traffic directly to the company's website rather than a link in their profile, which is the current trend. In addition, the tool 14 automatically gathers information about the company and categorizes it using algorithms to provide detailed information about a company to other users, such information that would otherwise be difficult to gather from the tedious and lengthy manual signup forms with an exhaustive list of questions. In most prior art cases, the profile set up process is typically abandoned out of frustration, or the profile is incorrectly completed during the manual set up process leading to misclassifications of the company or omission of products or services associated with the company. By having a website as a user's profile, several back-end steps and procedures, such as profile creation, may be avoided, as the companies signing up are responsible to update their websites and to adhere to industry standards. In addition, having a website as a user/company profile enables the B2B platform to integrate the user's/company's social media accounts directly into the platform.

As an example, a user can discover new direct and indirect competitors entering the market around the world by updating their lists on regular basis. Also, the user can monitor the content competitors update on their websites, such as new products, press releases, events, which can assist in spotting trends or market shifts.

In another embodiment, there is provided a geo-mapping tool that automatically extracts the locations of businesses in the URL list database 54 and displays them using the Google APIs, from Google Inc., U.S.A., based on the user's current location. The user can search for a specific niche product/service and the closest businesses in the vicinity will be displayed on the Google Maps in a user-friendly format to the user's liking After a website associated with an enterprise company is entered onto the platform using the auto tagging tool 14, the company's location, including any regional branches, is extracted from their website and is stored on the server 50. The extracted locations are indexed appropriately to match the company's products/services using complex queries on the extracted and crawled data. Once the index is created and stored on the server 50, the next step is to supply the information to Google APIs, specifically Google Geocode API and the Google Maps API. The company location is integrated with the company's webpage on the platform thus enhancing the user's experience.

The tool 14 provides an opportunity for users to easily discover new customers and suppliers through filtering results by categories, subcategories, location and keywords. The social aspect of the platform offers users quality results faster than any search engine and in some areas not available in many search engines. Users may also create lists of their suppliers and customers websites which act as a unique relationship management system for the company's sales and procurement departments.

In yet another embodiment, the auto tagging tool 14 incorporates social media tools to allow users to communicate directly with businesses by instantly selecting any business from a suitable map populated with businesses profiled on the B2B platform.

A service for premium members that offers detailed analytics for understanding what corporate entities are visiting the company's website. By knowing who is visiting the website, companies can increase the efficiency of their marketing programs. Marketers can also leverage the real time identification service to classify their audiences by company size and origination. This audience classification capability provides insight into the composition of web traffic, segmenting traffic by company size, specific verticals, and origin; this provides marketers with unique visibility into their website traffic. With this capability, marketers receive insight immediate insight to effectively analyze and measure their traffic, by detailed audience segments. Audience classification also provides marketers with the necessary insight to create targeted and relevant content to these segments, enabling them to create and deliver offers and content specific to an enterprise vs. and SMB company.

In another embodiment, the auto tagging tool 14 may also perform customer categorization, as the tool 14 is capable of differentiating between a B2B and a business to consumer (B2C) website. This feature enables the users to approach the appropriate supplier based on their niche requirements. The auto tagging tool 14 may also perform supply chain categorization, that is, categorizing and placing any given website in its appropriate position in the supply chain, thus enabling users to determine whether a company is a manufacturer, a distributor or a retailer.

The communication network 14 can include a series of network nodes (e.g., the clients and servers) that can be interconnected by network devices and wired and/or wireless communication lines (such as, public carrier lines, private lines, satellite lines, etc.) that enable the network nodes to communicate. The transfer of data between network nodes can be facilitated by network devices, such as routers, switches, multiplexers, bridges, gateways, etc., that can manipulate and/or route data from an originating node to a server node regardless of dissimilarities in the network topology (such as, bus, star, token ring, mesh, or hybrids thereof), spatial distance (such as, LAN, MAN, WAN, Internet), transmission technology (such as, TCP/IP, Systems Network Architecture), data type (such as, data, voice, video, multimedia), nature of connection (such as, switched, non-switched, dial-up, dedicated, or virtual), and/or physical link (such as, optical fiber, coaxial cable, twisted pair, wireless, etc.) between the correspondents within the network.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

1. A method for categorizing content from a website associated with an enterprise company for ranking of said company, said method performed by a computing device having a processing structure; and a memory including instructions executable by said processing structure, to cause said processing structure to at least:
request a uniform resource locator (URL) associated with said website;
validate said URL;
create a profile associated with said enterprise company and storing said URL in said memory;
automatically crawl said website for content and to create a site index;
parse the content to determine the occurrence of a predefined set of keywords pertaining to products and services and business activities of said company, and rank said keywords according to relevance pertaining to at least one category;
categorize said website into at least one category; and
determine whether the website is properly categorized.

2. The method of claim 1 wherein said processing structure is caused to automatically categorize said website into at least one category based on products and services.

3. The method of claim 1 wherein said at least one category comprises at least one subcategory.

4. The method of claim 3 wherein said at least one category is based on a set of keywords.

5. The method of claim 4 wherein said at least one category is associated with at least one of a business to business market (B2B) or a business to consumer (B2C) market.

6. The method of claim 5 wherein when said at least one category is associated with a B2B category, then said B2B category is derived using HS/NAICS codes.

7. The method of claim 6 wherein said HS/NAICS codes are used as a dictionary to refine said content based on said keywords.

8. The method of claim 7 wherein said enterprise company is classified as one of a supplier, a customer or a competitor.

9. The method of claim 8 wherein said processing structure is caused to provide a graphical user interface (GUI) having a plurality of icons or text associated with said least one category and said at least one sub-category, whereby selecting one of said icons or text displays at least one company assigned in said least one category and said at least one sub-category.

10. The method of claim 9 wherein said GUI comprises a search field for inputting a product and/or a service query for execution by said processing structure to provide at least one company matching said queried product and/or service.

11. An auto tagging system for categorizing a company, the system comprising:
a uniform resource locator (URL) validator to validate at least one URL associated with said company;
an email address verifier for verifying an email address associated with said company;
a URL list database;
a crawler for crawling a website associated with said least one URL for content to create a site index for entry in a crawler database,
a parser for parsing the content of said crawled at least one URL; and
a rank categorizer for categorizing at least one the URL into a category.

12. The system of claim 11 wherein said at least one URL is crawled periodically to update the site index and populate a database associated with the rank categorizer.

13. The system of claim 11 wherein said parser comprises a plurality of algorithms for determining the density of keywords.

14. The system of claim 13 wherein said parser ranks said keywords according to relevance pertaining to at least one category.

15. The system of claim 14 wherein said at least one category is one of a business to business (B2B) category and a business to consumer (B2C) category.

16. The system of claim 15 wherein said business to business (B2B) category is based on keywords derived using HS/NAICS codes.

17. A computer-implemented method for discovering content associated with a company, the method having the steps of:
categorizing content associated with said company into at least one category;
assigning a unique identifier to said company;
creating a profile of said company;
automatically crawling at least one uniform resource locator (URL) associated with a website of said company for content on a predetermined basis, and to create a site index;
parsing the content to determine the occurrence of a predefined set of keywords pertaining to products and services and business activities of said company;
ranking said keywords according to relevance pertaining to at least one category; and
providing said content in real-time based on predefined rules.

18. The computer-implemented method of claim 17 wherein said predefined rules comprise providing user-defined content.

19. The computer-implemented method of claim 18 wherein said predefined rules comprise providing content in response to a search query pertaining to at least one of a product, a service, or a business activity associated with said company.

20. The computer-implemented method of claim 19 wherein said content or said business activity is related to news associated with said company.
